(19) United States
(12) Patent Application Publication
(10) Pub. No.: US 2025/0005567 A1
(43) Pub. Date: Jan. 2, 2025

(54) BLOCKCHAIN-ENABLED ESG MANAGEMENT

(71) Applicant: INTERNATIONAL BUSINESS MACHINES CORPORATION, Armonk, NY (US)

(72) Inventors: Rachana Vishwanathula, Hyderabad (IN); Rahul Reddy Ravipally, Bengaluru (IN); Shanmugaraja Selvam, Ariyalur (IN); Srikanth Manne, Bengaluru (IN)

(21) Appl. No.: 18/345,736

(22) Filed: Jun. 30, 2023

(51) Int. Cl. G06Q 20/38; G06Q 40/04

(52) U.S. Cl. CPC G06Q 20/389; G06Q 40/04

(57) ABSTRACT

A first client device including a blockchain and associated with an environmental, social, and governance (ESG) management platform is configured to perform the following. A trading pair between two different sustainability factors is identified by the first client device. A transaction block for the trading pair is generated by the first client device. The transaction block is broadcasted by the first client device to a plurality of client devices associated with the ESG management platform. The blockchain is updated upon receipt of a network update, and the network update indicates that the transaction block was accepted by one of the plurality of client devices and a smart contract was generated based upon the transaction block being accepted.

### BACKGROUND

The present invention relates to blockchains, and more specifically, to using a blockchain to assist ESG management.

Investors are increasingly scrutinizing environmental, social and governance (ESG) performance—and looking for companies/enterprises to rise to the challenge of delivering ESG improvements. Consequently, enterprises are looking to provide sustainability leadership by setting organization-wide sustainability goals. This sustainability leadership involves capturing and reporting, in the form of ESG reports, an enterprise's ESG performance.

Several types of reporting exist depending upon the industry the organization is in. These standards include Global Reporting Initiative (GRI), Task Force on Climate-related Financial Disclosures (TCFD), Sustainability Accounting Standards Board (SASB), European Public Real Estate (EPRA) among others. Additionally, executive reports can be generated for organizations at a regional level, where energy, water, waste, and greenhouse gas emissions are captured and reported. An example of a software suite used to consolidate enterprise ESG data for analysis and reporting is IBM's Envizi ESG Suite.

ESG reporting is oftentimes divided into different scopes (e.g., Scope 1, Scope 2, and Scope 3). Scope 1 reports capture emissions that are directly generated by an enterprise and its controlled entities. Scope 2 reports captures emissions that are indirectly generated as a result of activities by an enterprise (e.g., the emissions used from the generation of purchased energy used by the enterprise). Scope 3 reports captures indirectly-generated emissions that are not included in Scope 2, and these include both upstream and downstream emissions. These emissions can include emissions generated as a result of employee travel and commuting, distribution of raw materials from suppliers, distribution of finished products to consumers, use of finished products, and end-of-life handling of products.

Depending upon the organization and its inherent characteristics, certain ESG goals may be easier to achieve than others. Moreover, this can vary between individual units of an organization, between various regions, or even between different enterprises. Consequently, while one organization/unit/region may reach a particular ESG goal, another organization/unit/region may not. In these instances, there is a need to encourage enterprises/organizations to operate in a manner that achieves overall sustainability leadership by meeting their ESG goals.

### SUMMARY

A method performed by a first client device including a blockchain and associated with an environmental, social, and governance (ESG) management platform includes the following. A trading pair between two different sustainability factors is identified by the first client device. A transaction block for the trading pair is generated by the first client device. The transaction block is broadcasted by the first client device to a plurality of client devices associated with the ESG management platform. The blockchain is updated upon receipt of a network update, and the network update indicates that the transaction block was accepted by one of the plurality of client devices and a smart contract was generated based upon the transaction block being accepted.

Additionally, the trading pair defines a trade threshold between the two different sustainability factors, and the ESG management platform automatically determines the trade threshold based upon regional demand. The two different sustainability factors are selected from a group consisting of: energy, water, waste, and emissions. The smart contract identifies conditions associated with the transaction block and two parties that have accepted the transaction block, and the smart contract is appended to the block chain. The network update includes a change to the block chain based upon the smart contract being appended to the blockchain. The two parties are selected from a group consisting of: two different regions, two different units with a same enterprise, and two different enterprises.

A first client device including a blockchain and associated with an environmental, social, and governance (ESG) management platform includes a hardware processor configured to initiate the following executable operations. A trading pair between two different sustainability factors is identified by the first client device. A transaction block for the trading pair is generated by the first client device. The transaction block is broadcasted by the first client device to a plurality of client devices associated with the ESG management platform. The blockchain is updated upon receipt of a network update, and the network update indicates that the transaction block was accepted by one of the plurality of client devices and a smart contract was generated based upon the transaction block being accepted.

Additionally, the trading pair defines a trade threshold between the two different sustainability factors, and the ESG management platform automatically determines the trade threshold based upon regional demand. The two different sustainability factors are selected from a group consisting of: energy, water, waste, and emissions. The smart contract identifies conditions associated with the transaction block and two parties that have accepted the transaction block, and the smart contract is appended to the block chain. The network update includes a change to the block chain based upon the smart contract being appended to the blockchain. The two parties are selected from a group consisting of: two different regions, two different units with a same enterprise, and two different enterprises.

A computer program product comprises a computer readable storage medium having stored therein program code. The program code, which when executed by a first client device including a blockchain and associated with an environmental, social, and governance (ESG) management platform, causes the first client device to perform the following. A trading pair between two different sustainability factors is identified by the first client device. A transaction block for the trading pair is generated by the first client device. The transaction block is broadcasted by the first client device to a plurality of client devices associated with the ESG management platform. The blockchain is updated upon receipt of a network update, and the network update indicates that the transaction block was accepted by one of the plurality of client devices and a smart contract was generated based upon the transaction block being accepted.

Additionally, the trading pair defines a trade threshold between the two different sustainability factors, and the ESG management platform automatically determines the trade threshold based upon regional demand. The two different sustainability factors are selected from a group consisting of: energy, water, waste, and emissions. The smart contract identifies conditions associated with the transaction block and two parties that have accepted the transaction block, and the smart contract is appended to the block chain. The network update includes a change to the block chain based upon the smart contract being appended to the blockchain. The two parties are selected from a group consisting of: two different regions, two different units with a same enterprise, and two different enterprises.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIGS. 1A and 1B are block diagrams respectively illustrating an example architecture of an ESG management platform and associated client device according to an embodiment of the present invention.

FIG. 2 is a block diagram illustrating an exemplary method of employing the ESG management platform of FIG. 1 according to an embodiment of the present invention.

FIG. 3A is an example of an ESG report according to an embodiment of the present invention.

FIG. 3B illustrates different trading pairs according to an embodiment of the present invention.

FIG. 4 illustrates another example of an ESG report according to an embodiment of the present invention.

FIG. 5 is a block diagram illustrating an example of computer environment for implementing portions of the methodology of FIG. 2.

### DETAILED DESCRIPTION

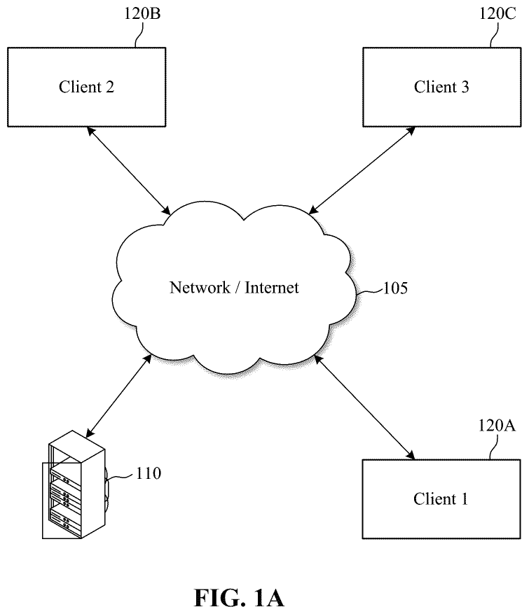

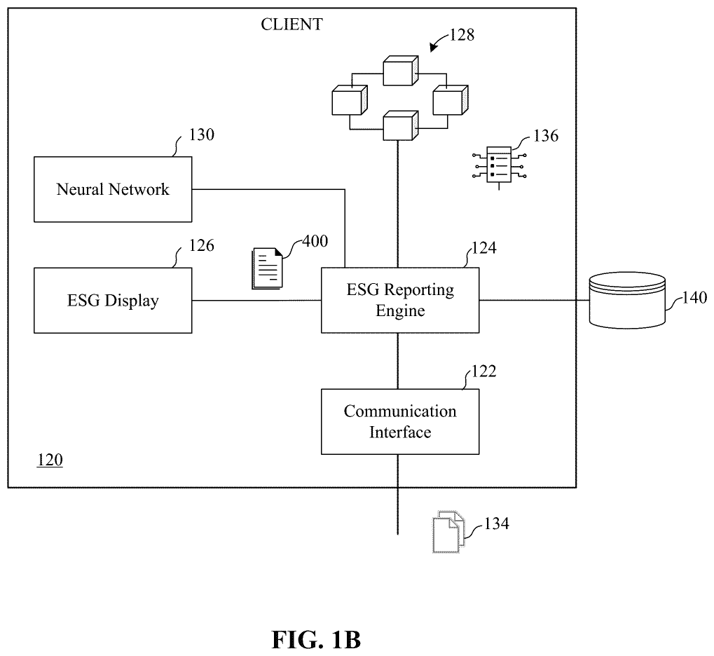

FIGS. 1A and 1B respectively illustrate an exemplary environmental, social, and governance (ESG) management platform 100 and associated client device 120. Although discussed in more detail below, a first client device 120 includes a blockchain 128 associated with the ESG management platform 100. A trading pair between two different sustainability factors is identified by the first client device 120. A transaction block 134 for the trading pair is generated by the first client device 120. The transaction block 134 is then broadcasted by the first client device 120 over a network 105 to a plurality of other client devices 120A-C associated with the ESG management platform 100. The blockchain 128 is updated upon receipt of a network update, and the network update indicates that the transaction block 134 was accepted by one of the plurality of client devices 120A-C and a smart contract 136 was generated based upon the transaction block 134 being accepted. Although many of the processes discussed below are described as being performed by the ESG reporting engine 124 within the client device 120, one or more of those functions can also be performed by a centralized ESG management server 110 that is associated with the ESG management platform 100.

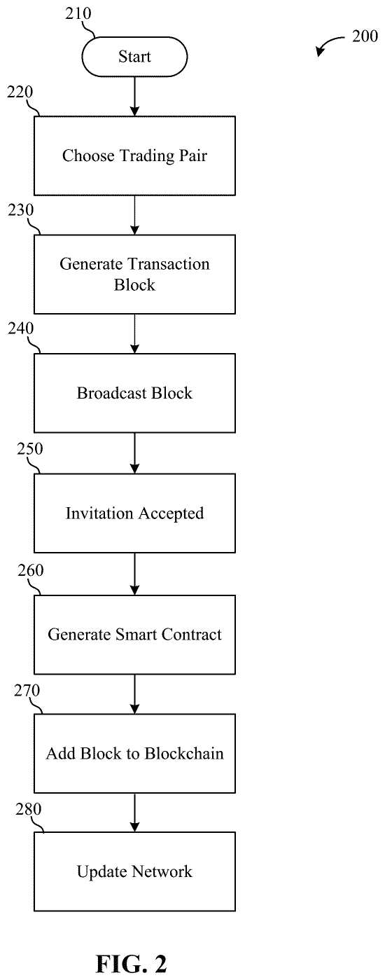

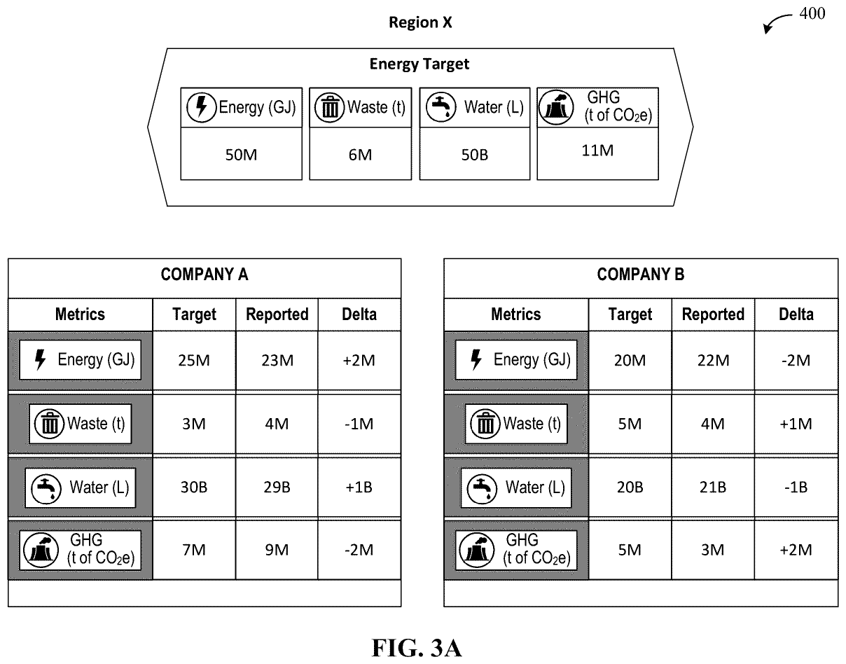

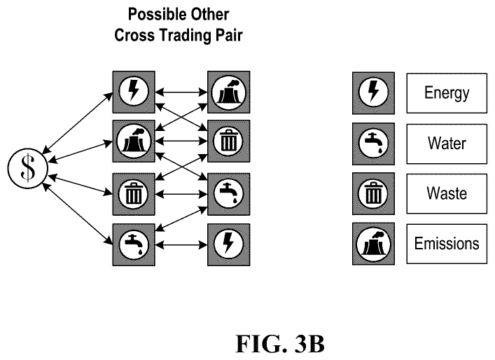

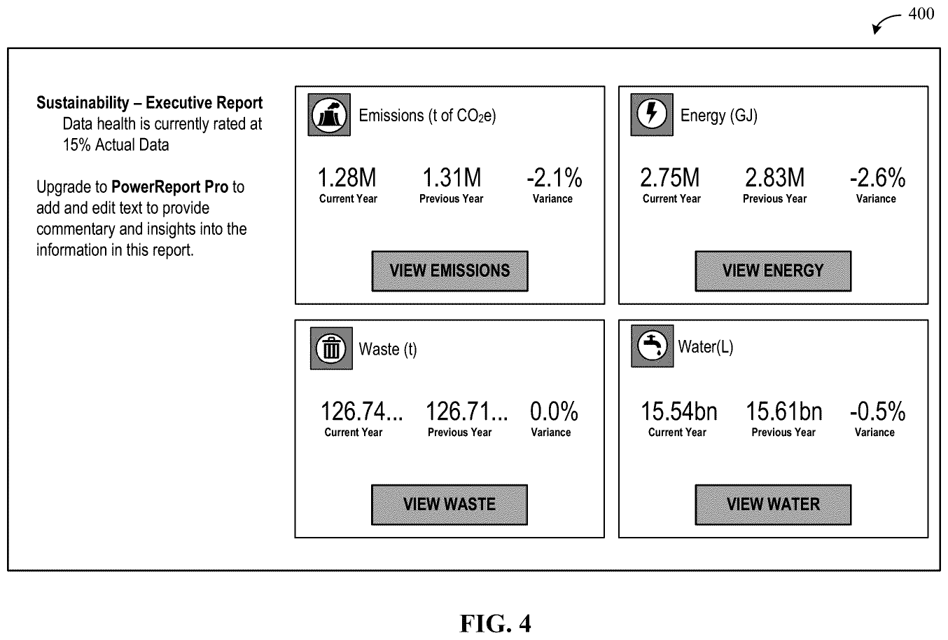

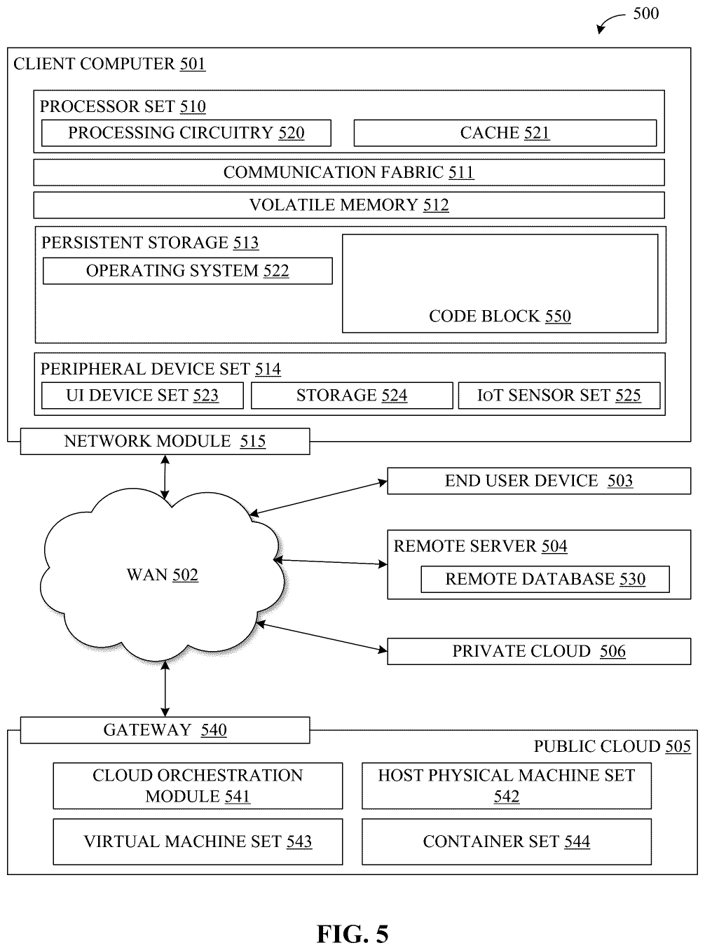

With reference to FIG. 2, an overview of the general process 200 for providing and employing an ESG management platform 100 is disclosed. In 210, the process 200 begins. This can include the generation of an ESG report 400 by the ESG reporting engine 124—example ESG reports 400 are illustrated in FIGS. 3A and 4. As previously discussed, the generation of ESG reports 400 involves known technology, and the ESG reporting engine 124 is not limited to a particular technology so capable. The generation of the ESG report 400 can include high-level metrics such as energy, water, waste, and emissions (e.g., greenhouse gas emissions). The ESG report 400 can be broken down in various degrees, such as by region, by unit, and by company. The ESG report 400 can compare current numbers with past years, along with target goals, reported amounts, and a delta difference between the goal and actual amounts.

Although not limited in this manner, the ESG report 400 can report categories such as captured emissions of CO₂, energy, waste and water consumed by an organization. The ESG report 400 can also compare the values for those categories with a previous year and a differential percentage. The ESG report 400 is also configured to be further drilled down to permit a user to understand what data contributed to each reported value. For example, data such as electricity bills can be used to calculate energy consumption, and data such as water bills can be used to calculate water report. This data can be retrieved from external sources 140. As is known in the art, the ESG report 400 can be set to Scope 1, Scott 2, or Scope 3 based on the level of data is going into the ESG report 400.

In 220, a trading pair is identified, and the trading pair identifies the sustainability factors that will be involved in the trade. With reference to FIG. 3B, examples of trading pairs include: (i) energy to energy, energy to water, energy to waste, energy to GHG, and energy to monetary assets; (ii) water to energy, water to waste, water to water, water to GHG, and water to monetary assets; (iii) waste to energy, waste to waste, waste to water, waste to GHG, and waste to monetary assets; and (iv) GHG to energy, GHG to waste, GHG to water, GHG to GHG, and GHG to monetary assets. Other trading pairs are also possible.

Although not limited in this manner, the ESG reporting engine 124 in conjunction with data provided by a user interacting with the ESG display 126, to identify a trading pair based upon goals set for a particular enterprise, unit, and/or region. For example, if a producer requires a reduction in water usage to meet an overall sustainability goal and has an excess in reduction of energy emissions, the trading pair can be energy to water.

In 230, the ESG reporting engine 124 generates a transaction block 134 that identifies the sustainability factors of the trading pair. Additionally, the transaction block 134 can include a proposed ratio between the sustainability factors. For example, if a water reduction is needed more than an emissions reduction in meeting an overall sustainability goal, ratio can favor the water reduction sustainability factor of the emissions sustainability factor. This ratio can be determined from input provided by the user using the ESG display 126 or automatically by the ESG reporting engine 124 in conjunction with a neural network 130 using historical data contained in the blockchain 128 about past trades.

In 240, the originating client 120 can broadcast the transaction block 134 via a communication interface 122 over the network 105 to other client devices 120A-C, respectively associated with other regions/units/organizations, of the ESG management platform 100. Although not limited in this manner, the ESG reporting engine 124 can prioritize certain other regions/units/organizations based upon an overall sustainability portfolio requirement.

In 250, one of the client devices 120A-C can accept the invitation for a trade indicated by the transaction block 134. In 260, based upon the acceptance of the invitation, a smart contract 136 that defines the terms and conditions of the trade defined within the proposed transaction block 134 is generated by the ESG reporting engine 124. Smart contracts 136 are self-executing contracts in which the agreement is inscribed directly into lines of software code. Smart contracts 136 are also known technology, and the ESG reporting engine 124 is not limited as to a particular type of smart contract 136. Many smart contracts 136 are intended to operate in conjunction with a blockchain 128. Consequently, in 270, after the smart contract 136 is generated, a block that represents the smart contract 136 is appended to the blockchain 128.

Th ESG reporting engine 124 can also generate the smart contract 136 by taking into account trade conditions and portfolios of the parties involved. The smart contract 136 can also take into accounts factors in regional requirements and automatically generate terms and conditions for smart contract 136 based upon those regional requirements.

In 280, in a distributed blockchain 128 system, the changes to the blockchain 128 (e.g., the block representing the smart contract 136 being appended to the blockchain 128) are distributed to the blockchains 128 being hosted by the other clients 120A-C as well as the ESG management server 110. In this manner, overall sustainability goals for a region/unit/enterprise can be maintained.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 4, computing environment 400 contains an example of an environment for the execution of at least some of the computer code involved in performing the inventive methods, such as code block 450 for implementing the operations of the ESG management platform 100, ESG managing server 110, and client devices 120A-C. Computing environment 400 includes, for example, computer 401, wide area network (WAN) 402, end user device (EUD) 403, remote server 404, public cloud 405, and private cloud 406. In certain aspects, computer 401 includes processor set 410 (including processing circuitry 420 and cache 421), communication fabric 411, volatile memory 412, persistent storage 413 (including operating system 422 and method code block 450), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. However, to simplify this presentation of computing environment 400, detailed discussion is focused on a single computer, specifically computer 401. Computer 401 may or may not be located in a cloud, even though it is not shown in a cloud in FIG. 4 except to any extent as may be affirmatively indicated.

Processor set 410 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In certain computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in code block 450 in persistent storage 413.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 411 is the signal conduction paths that allow the various components of computer 401 to communicate with each other. Typically, this communication fabric 411 is made of switches and electrically conductive paths, such as the switches and electrically conductive paths that make up busses, bridges, physical input/output ports and the like. Other types of signal communication paths may be used for the communication fabric 411, such as fiber optic communication paths and/or wireless communication paths.

Volatile memory 412 is any type of volatile memory now known or to be developed in the future. Examples include dynamic type random access memory (RAM) or static type RAM. Typically, the volatile memory 412 is characterized by random access, but this is not required unless affirmatively indicated. In computer 401, the volatile memory 412 is located in a single package and is internal to computer 401. In addition to alternatively, the volatile memory 412 may be distributed over multiple packages and/or located externally with respect to computer 401.

Persistent storage 413 is any form of non-volatile storage for computers that is now known or to be developed in the future. The non-volatility of the persistent storage 413 means that the stored data is maintained regardless of whether power is being supplied to computer 401 and/or directly to persistent storage 413. Persistent storage 413 may be a read only memory (ROM), but typically at least a portion of the persistent storage 413 allows writing of data, deletion of data and re-writing of data. Some familiar forms of persistent storage 413 include magnetic disks and solid state storage devices. Operating system 422 may take several forms, such as various known proprietary operating systems or open source Portable Operating System Interface type operating systems that employ a kernel. The code included in code block 450 typically includes at least some of the computer code involved in performing the inventive methods.

Peripheral device set 414 includes the set of peripheral devices for computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some aspects, storage 424 may take the form of a quantum computing storage device for storing data in the form of qubits. In aspects where computer 401 is required to have a large amount of storage (for example, where computer 401 locally stores and manages a large database) then this storage 424 may be provided by peripheral storage devices designed for storing very large amounts of data, such as a storage area network (SAN) that is shared by multiple, geographically distributed computers. Internet-of-Things (IoT) sensor set 425 is made up of sensors that can be used in IoT applications. For example, one sensor may be a thermometer and another sensor may be a motion detector.

Network module 415 is the collection of computer software, hardware, and firmware that allows computer 401 to communicate with other computers through a Wide Area Network (WAN) 402. Network module 415 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 415 are performed on the same physical hardware device. In other aspects (for example, aspects that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any Wide Area Network (for example, the internet) capable of communicating computer data over non-local distances by any technology for communicating computer data, now known or to be developed in the future. In some aspects, the WAN 402 ay be replaced and/or supplemented by local area networks (LANs) designed to communicate data between devices located in a local area, such as a Wi-Fi network. The WAN 402 and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In certain aspects, EUD 403 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404. As defined herein, the term “server” means a data processing system configured to share services with one or more other data processing systems.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other aspects, a private cloud 406 may be disconnected from the internet entirely (e.g., WAN 402) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 405 and private cloud 406 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including.” “comprises,” and/or “comprising.” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement.” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement.” “one aspect.” “an aspect,” and similar language throughout this disclosure may, but do not necessarily, all refer to the same embodiment.

The term “plurality.” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting.” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if.” “when.” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A method by a first client device including a blockchain and associated with an environmental, social, and governance (ESG) management platform, comprising:
identifying, by the first client device, a trading pair between two different sustainability factors;
generating, by the first client device, a transaction block for the trading pair;
broadcasting, by the first client device, the transaction block to a plurality of client devices associated with the ESG management platform; and
updating the blockchain based upon receipt of a network update, wherein
the network update indicates that the transaction block was accepted by one of the plurality of client devices and a smart contract was generated based upon the transaction block being accepted.

2. The method of claim 1, wherein
the trading pair defines a trade threshold between the two different sustainability factors.

3. The method of claim 2, wherein
the ESG management platform automatically determines the trade threshold based upon regional demand.

4. The method of claim 2, wherein
the two different sustainability factors are selected from a group consisting of: energy, water, waste, and emissions.

5. The method of claim 1, wherein
the smart contract identifies conditions associated with the transaction block and two parties that have accepted the transaction block.

6. The method of claim 5, wherein
the smart contract is appended to the block chain, and
the network update includes a change to the block chain based upon the smart contract being appended to the blockchain.

7. The method of claim 5, wherein
the two parties are selected from a group consisting of:
two different regions,
two different units with a same enterprise, and
two different enterprises.

8. A first client device associated with an environmental, social, and governance (ESG) management platform, comprising:
a storage device having stored therein a blockchain, and
a hardware processor configured to initiate the following executable operations:
identifying, by the first client device, a trading pair between two different sustainability factors;
generating, by the first client device, a transaction block for the trading pair;
broadcasting, by the first client device, the transaction block to a plurality of client devices associated with the ESG management platform; and
updating the blockchain based upon receipt of a network update, wherein
the network update indicates that the transaction block was accepted by one of the plurality of client devices and a smart contract was generated based upon the transaction block being accepted.

9. The first client device of claim 8, wherein
the trading pair defines a trade threshold between the two different sustainability factors.

10. The first client device of claim 9, wherein
the ESG management platform automatically determines the trade threshold based upon regional demand.

11. The first client device of claim 9, wherein
the two different sustainability factors are selected from a group consisting of: energy, water, waste, and emissions.

12. The first client device of claim 8, wherein
the smart contract identifies conditions associated with the transaction block and two parties that have accepted the transaction block.

13. The first client device of claim 12, wherein
the smart contract is appended to the block chain, and
the network update includes a change to the block chain based upon the smart contract being appended to the blockchain.

14. The first client device of claim 12, wherein
the two parties are selected from a group consisting of:
two different regions,
two different units with a same enterprise, and
two different enterprises.

15. A computer program product, comprising:
a computer readable storage medium having stored therein program code,
the program code, which when executed by a first client device including a blockchain and associated with an environmental, social, and governance (ESG) management platform, causes the first client device to perform:
identifying, by the first client device, a trading pair between two different sustainability factors;
generating, by the first client device, a transaction block for the trading pair;
broadcasting, by the first client device, the transaction block to a plurality of client devices associated with the ESG management platform; and
updating the blockchain based upon receipt of a network update, wherein the network update indicates that the transaction block was accepted by one of the plurality of client devices and a smart contract was generated based upon the transaction block being accepted.

16. The computer program product of claim 15, wherein
the trading pair defines a trade threshold between the two different sustainability factors.

17. The computer program product of claim 16, wherein
the ESG management platform automatically determines the trade threshold based upon regional demand.

18. The computer program product of claim 16, wherein
the two different sustainability factors are selected from a group consisting of: energy, water, waste, and emissions.

19. The computer program product of claim 15, wherein
the smart contract identifies conditions associated with the transaction block and two parties that have accepted the transaction block.

20. The computer program product of claim 19, wherein
the smart contract is appended to the block chain,
the network update includes a change to the block chain based upon the smart contract being appended to the blockchain, and
the two parties are selected from a group consisting of:
two different regions,
two different units with a same enterprise, and
two different enterprises.
